(19) United States
(12) Patent Application Publication
(10) Pub. No.: US 2019/0120871 A1
(43) Pub. Date: Apr. 25, 2019

(54) SENSOR ELEMENTS TO DETECT OBJECT MOVEMENT RELATIVE TO A SURFACE

(71) Applicant: PAYPAL, INC., San Jose, CA (US)

(72) Inventor: Braden Christopher Ericson, San Jose, CA (US)

(21) Appl. No.: 15/789,865

(22) Filed: Oct. 20, 2017

(51) Int. Cl. G01P 13/00

(52) U.S. Cl. CPC G01P 13/00

(57) ABSTRACT

There are provided systems and methods for sensor elements to detect object movement relative to a surface. A computing device, such as a mobile smart phone, may include one or more sensors mounted within, surrounding, or nearby structural components of the computing device, such as an attachable sensor or device casing. The sensor(s) may be capable of determining a movement of the device relative to a particular surface. A user may place a device on a surface, such as a table or other furniture piece. The device may begin to move or slip on the surface, which may be detected by the sensor(s) by determining any movement related input to the sensor. If the movement data detected by the sensor meets a condition or threshold amount that requires notification to the user to prevent damage to the device, such as fall damage, a notification may be output.

### TECHNICAL FIELD

The present application generally relates to detecting and measuring object movement through surface or embedded sensors in the object and more specifically to one or more sensor elements that detect movement of a computing device relative to a surface to prevent device damage.

### BACKGROUND

Mobile computing devices may allow for a variety of inputs through various input mechanisms and/or sensors, including touch screen inputs, motion sensitive elements within the device, audio input devices, and/or imaging/video input devices. These input devices allow users to perform a variety of inputs, and allow the device to capture data. However, these input devices generally function with a user or require user input and attention during use. Moreover, with the increasing miniaturization of devices and the complexity of the devices, these mobile devices have become increasing prone to physical damage that may adversely affect device performance or entirely disable the device. Impact damage has become an increasingly large problem as the cost of mobile devices increases, and the size of mobile devices decreases. Although users may take certain precautions, including attaching impact resistant cases to their mobile devices, this adds additional weight, cost, and/or size that users may not want. These impact resistant cases are also remedial in nature so that they only provide protection when impact damage occurs, and therefore do not provide preventative protection to the device. Thus, users require a way to be notified of potential impact damage to their device, especially when the device may not be in close physical contact or hand possession of the user.

### BRIEF DESCRIPTION OF THE DRAWINGS

FIG. 1 is a block diagram of a networked system suitable for implementing the processes described herein, according to an embodiment;

FIG. 2A is an exemplary device system for detecting movement or motion of the device system relative to a surface, according to an embodiment;

FIG. 2B is an exemplary environment including a mobile device in physical contact with a first surface and nearby a second surface, which may be used to determine a movement or motion of the device relative to the first surface and/or second surface, according to an embodiment;

FIG. 3 is an exemplary system environment showing a communication device of a user receiving data for a movement or motion of the device and determining whether to output a notification to a user of the movement or motion, according to an embodiment;

FIG. 4 is a flowchart of an exemplary process used by sensor elements to detect object movement relative to a surface, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for sensor elements to detect object movement relative to a surface and to then provide a notification through the object of such movement. Systems suitable for practicing methods of the present disclosure are also provided.

A computing device may include a movement or motion sensitive element attached to the computing device, such as including within or connected to a structural body, screen, attachable casing (e.g., a device holder, protective sleeve, connectable protector, or other casing type device), or other structural component of the computing device, including connectable components of the computing device. As discussed herein, motion and movement are used interchangeably, and are used to refer to one or more of a directional velocity of the computing device, an acceleration rate of the computing device in one or more directions, a vibration of the computing device, or another force exerted on the mobile device that causes the mobile device to move in one or more directions. In this regard, the motion sensitive element may correspond to a sensor or other component that may be configured to detect motion or movement data or input, for example, through one or more of a gyroscope, an accelerometer, a friction sensor, an ultrasonic radar system, an electromagnetic radar system, and/or a camera. The sensor may be a separate or integrated sensor in the device. For example, the sensor may correspond to an internal sensor or device of the computing device, as described above, or a separate and connectable sensor or device, such as an attachable sensor that may be wired or wirelessly connected to the computing device and may be physically connected to (e.g., attached to) the computing device or nearby the device, such as located on or connected to the same surface that the computing device may be resting on. In various embodiments, one or more sensors may also be included with or embedded within an attachable casing or shell for the computing device, such as a battery or protective case.

Thus, the motion sensor of the computing device may include particular electronic components and devices to detect a movement or motion, and a degree or amount of the movement/motion. For example, the movement or motion may correspond to a velocity or acceleration of the device, which may be measured in a single direction or multiple directions, including a circular direction, back-and-forth direction (e.g., vibration or vibrational frequency of direction), or any other 1, 2, or 3-dimensional direction. The movement or motion may be determined by or correspond to another type of force exerted on the sensor and/or computing device, including a friction force between the sensor and one or more surfaces, or a pressure detected by the sensor that is applied to the device. The movement or motion may also correspond to a distance covered, which may be measured based on both the velocity/acceleration and the time at the velocity/acceleration or based on a change in position/location of the device. Thus, the movement or motion may correspond to one or more of the aforementioned computed values, and may be determined using data detected and/or collected by the sensor. For example, a gyroscope and/or accelerometer may detect measurements of velocity and/or acceleration as forces applied to the device and/or sensor, whereas a radar or camera may be used to detect change in location, distance travelled, and/or environment. A digital camera may be used to track a change in location or a distance traveled, or may measure changes in captured images/video of an environment to determine a change in location or a distance traveled by the device. Other data may also be captured, such as a friction force applied to a sensor and an amount/length of the friction as indicating that the device is in movement and/or an amount of movement. The amount of movement (e.g., distance traveled, velocity, and/or acceleration) may be determined using a stored or determined co-efficient of friction for a surface in contact with the friction sensor. Other types of tactile sensors may also be used to determine that a device is in motion, including a touch screen interface having a resistive or capacitive touch screen that may detect certain new inputs to the touch screen. Tactile sensors may also measure change in surface type, texture, or other parameter to determine a change in motion or movement.

The computing device may include one or more processing applications and/or additional device components that may detect and/or receive motion data from one or more of the aforementioned sensors. The application(s) and the component(s) may further provide the information to additional processing systems of the computing device for use in operating systems, applications, and application interfaces of the computing device. For example, one or more applications of the computing device may be configured to receive input data for the movement/motion through the sensor of the computing device. A motion sensitive application of the computing device may define a process or action executable when motion data is detected by the sensor. The application may set or define the process or action as executable in response to detecting any motion of the device, or when the motion meets, satisfies, or exceeds a condition, parameter, or threshold amount for the process/action. For example, the application may execute the process or action on detection of a movement/motion of the device using one or more sensors, or if the motion data captured by the sensor meets or exceeds a set threshold or amount that initiates the process/action. Thus, if the sensor detects certain motion data, then the data may cause execution of a process within the application or by another device application. The executable process or action linked to specific motion data may correspond to an alert or notification that the device is in motion or has been moved.

The amount of the motion data (e.g., the number of an individual input or a number of multiple inputs) may also be used to determine the alert or notification, for example, by having different notifications for lower or higher degrees of motion/movement. Additionally, as with the case of satisfying a condition or threshold, the value of the motion data captured by the sensor may be required to be within a certain range or meeting/exceeding a specific value or the corresponding process/action will not be initiated and/or executed. In other embodiments, the application may define two or more associated movement requirements or inputs, which each associated detected motion data is associated with different executable process/action. The application may pre-set the value of the motion data that may be required for a condition/threshold, which may be provided to the user through a tutorial interface, or the application may pre-set that any motion data may cause initiation of a process. The application may also allow the user to enter the required thresholds, if any, for the motion data and corresponding notifications, as well as customize the notifications associated with specific motion data captured by the sensor.

The application may also run in the background of an operating system of the computing device, which may be actively executed in response to a request for motion detection of the device and/or certain conditions that require motion detection. In other embodiments, the application may instead be one or more subroutines in one or more libraries shared between multiple applications that only execute in response to the request or conditions that indicate motion detection is required. For example, the user of the device may request that motion detection of the device be turned on and monitored, such as when the user begins working and places the device on a desk, stand, or other piece of furniture. The request may be entered, and then motion detection may be monitored by the device as described herein. In other embodiments, the device may determine when motion detection is required, for example, by detecting that the user has placed the device on a piece of furniture, is no longer holding the device, or has otherwise released physical control of the device.

In order to determine that the device's placement requires motion detection, one or more sensors of the device may be utilized, including the sensors described above. For example, a tactile or friction sensor may detect a desk touching the sensor/device, whereas an accelerometer or gyroscope may detect that the device has been placed on a surface. The accelerometer or gyroscope may also detect a horizontal, vertical, or other phone position that is indicative of being placed on a surface. A camera may detect that the camera is now adjacent or connected to a desk, is pointed upwards at a ceiling, or can no longer capture the image of the user (e.g., with regard to a forward facing camera, which may further utilize facial recognition to identify the user). Additionally, a pressure sensor, touch screen interface, or other sensor configured to detect that a user is holding the device may be utilized to detect a presence of the user through the user's hand or grip. Other types of physical connections may also be released or engaged to determine whether to monitor for motion detection, for example, a car holder usable for a GPS/mapping application for the device. Thus, if the application/processes determine that motion detection is required, for example, if the device is free without being held or otherwise connected to a person, surface, or other physical entity, the application/processes may monitor for motion data. In other embodiments, the application or processes may continuously be monitoring for motion detection without requiring a prerequisite request or condition to do so.

One or more sensors may detect motion data as described herein, for example, when the computing device is freely laying on a surface and begins to move, slip, or fall from the surface. The motion data may correspond to an amount, measurement, number or other quantitative value that indicates that the device has moved, is or was in motion, or may be at risk of being in motion (e.g., based on nearby sounds, captured video, etc.). The motion data may be captured relative to a surface, such as a surface that the device is in contact with, attached to, or nearby. The surface may correspond to a surface physically in contact with the device/sensor, or a remote surface that is not physically connected to the device but in the same environment (e.g., nearby ceiling, walls, or a floor). The motion data may be related to the surface so that the motion data is detected by the sensor/device with the surface and is relational to the surface. Thus, the motion data may be one of the aforementioned quantitative values measured relative to or with the surface, such as a friction force between the sensor/device and the surface, a movement/motion with respect to the surface, or other measured value of movement/motion of the device relative to the surface. Thus, the motion data may be indicative of a motion/movement status where the device risks falling or impact damage based on the current motion/movement of the device relative to the surface. The sensor of the device may capture the motion data and provide the motion data to the application for processing and determination of whether to execute an action or process.

Motion data may then be processed to determine what the captured motion is/was between the device and the surface. Once calculated or determined, the motion of the device may be associated with further information that defines a process or action to take based on the motion, for example, an alert or notification that should be generated and/or output based on the motion. The process or action may depend on the location of the motion input, number of inputs at the same time or in sequence, and/or length of an input. The process or action may also depend on an orientation of the phone when the motion data is captured, such as a vertical, horizontal, or other orientation, including a portrait or landscape orientation of a home screen/media capture screen. The process or action may require that any motion be detected, or may require that the motion meet or exceed a threshold amount, or otherwise satisfy a condition or parameter that must be met to cause output of the notification. For example, a minimum distance traveled, velocity, or acceleration may be required to be met before a notification is triggered based on the motion data.

Based on the motion data, as well as any other parameters, the process/action may be determined using one or more processes/actions set for that motion determined using the motion data. The application detecting and processing the motion data may set the notifications, or the notifications may be set with multiple applications where the processes described herein correspond to a subroutine executed by multiple applications. In certain embodiments, the notification may correspond to an audio, visual, or audiovisual notification or alert output by the computing device, or by an output device contained with, connect to, or associated with the device. For example, the notification may be a text alert on a display screen of the device, an audio alert through a speaker of the device and/or headphone connected to the device, or both a visual alert on a display screen, LED, or other visual output component of the device and an audio alert through the speaker/headphones. An audio alert or notification may include a chime, ping, or other noise indicator, whereas a visual alert may include a color display, flashing light/display, emoji or emote, or other visual indicator. In further embodiments, an alert/notification may include spoken phrases and/or text, including a message to the user, which may be general (e.g., “alert!” or “phone slipping!”), or may be set by the user and specific to the particular motion. Moreover, the message may also include motion data, such as an amount of movement/motion that has or is occurring, a status of the motion, a threshold crossed or condition met for the alert (e.g., “the phone has moved 5 cm”), or other data captured in the motion data. In other embodiments, the notification may be through a different user device attached to or in possession of the user. This may be valuable if the device on the surface is at such a distance or within an environment (e.g., noisy) that the user may not see or hear the notification from the device in or to be in motion.

The user of the computing device may configure the application with a motion amount for each input, where the motion amount for each input executes a particular application process or action established for the motion. In this regard, the user may access a configuration menu to establish motions and their motion data captured by one or more sensors, where a motion causes execution of an action within an application. In various embodiments, a single motion may be set, which may or may not have a required condition/threshold, or multiple motions each having different motion data, which also may or may not have a required condition/threshold. Thus, motion data may be associated with multiple actions depending on the amount of motion, location of the detected motion and/or force, number or degree of motion, length of motion, or other data point for the motion data. Thus, the application may include a preconfigured notifications and/or alerts. The user may also configure the motion and associated notification (or other action/process) entered using the configuration menu of the application with the sensor for capturing motion data. For example, using a setup/configuration process, the user may select a first process/action (e.g., a first notification) and select one or more motion or movement parameters (e.g., a distance moved, velocity rate, acceleration rate, etc.). The user may also allow the sensor to detect a motion and then set a notification, for example, by shaking the device or allowing the device to slip on a surface an amount the user desires. The user may then further select additional motions and associated notifications. Moreover, in certain embodiments, the user may set the motion to be amount independent, so that an action is executed based on just detecting the motion, or the user may select a threshold or condition/parameter required to be met or exceeded (e.g., only outputting the notification when the movement of a device is more than X distance, or the velocity/acceleration is over Y).

The configuration setup may utilize a plurality of motion inputs (e.g., movement distances, velocities, accelerations, friction forces, etc.) to establish a motion for different actions taken. The application may include a preconfigured or adjustable variance for the motion, or may require the motion to meet a minimum or maximum amount prior to execution of the process. Such preferences may be set when establishing motions and associated notifications. The actions may be selected from a menu or otherwise entered to the application (e.g., recording an action taken by a user, entry of computer code to a configuration process, etc.). The user may also provide sound, text, or media (e.g., image/video) input that may be used with a motion for the notification, such as a recording of the user's voice or entered text to be put in a notification. Processes and/or actions may also be implemented in other types of applications, including messaging applications, telephonic applications, social networking applications, fitness trackers and applications, media sharing or viewing applications, imaging application (e.g., a camera and associate application), microblogging applications, web browsing applications, and/or other types of applications. The action may also correspond to an emergency action to execute in the case of an emergency by the user (e.g., a call or emergency message to an authority entity, such as the police). The emergency action may further include a geo-location of the user determined using the device, such as through a GPS locator of the device. In other embodiments, the actions may be executed with the device's operating system, including menu selections, locking of interfaces, application execution, or other operating system process.

Additionally, the application and/or processes may determine when a condition has been met that may cause the device to stop detecting motion data and/or outputting notifications. For example, a user may be detected as holding a device based on input of a passcode, personal identification number (PIN), or biometric. Pressure inputs may also indicate presence of a hand's grip or connection to a holding structural device (e.g., in-car connection structure to hold the device). Orientation of the device may also indicate the device is no longer on a surface. Additionally, the friction sensor or tactile sensor of the device may no longer detect a connection to a surface, or may detect the presence of a user. Other types of data may also be captured, including image or video data indicating that the device is no longer placed on a surface or out of the control of a user where slip and impact damage may occur. After detection of such an event, the application may disable motion detection and/or outputting of notifications in response to certain motion data that indicates potential impact damage. Such processes may be disabled until detection of a condition of potential impact damage, as discussed herein.

The device may also detect velocity and/or acceleration changes, or positional changes, that may be used to turn off a currently active notification, such as a notification that the device is in danger of falling or otherwise in motion. For example, the device may detect motion data that causes generation and/or output of a notification that the device is in motion (e.g., in risk of a fall and/or other damage to the device). During the motion of the device, new or second motion data may be detected and/or the motion data may be updated based on changes to the motion. The new or changed data may correspond to motion data that indicates the device is no longer in motion or that the device has been secured (e.g., grasped by a hand or connected to a restraint, clasp, or other securing mechanism). Such data may indicate that the device is no longer in motion and/or is no longer in danger of fall/damage. Based on the new data, the device may determine whether the recommendation currently being output by the device is still necessary. If the new or changed motion data indicates that the requirements to output the notification are no longer satisfied, and/or that the new or changed motion data indicates that device is no longer in motion or danger of damage (e.g., if the new or changed motion data meets or satisfied a condition or parameter that causes output of the notification to stop), the device may stop output of the notification and/or delete the notification.

In further embodiments, an additional notification may be required, for example, if the device has fallen and is either damaged or may now be misplaced. The device may detect ambient conditions surrounding the device to determine whether the additional notification is necessary. The ambient conditions may be indicative of a location of misplacement of the device where the user may have difficulty finding the device, for example, under an object or concealed by one or more objects. The ambient conditions may therefore indicate a light level (e.g., low light where the phone may be hidden or a camera obscured), a noise level, and/or a location/position determined based on the movement or a location detection system of the device. The device may also detect impact through a pressure sensor, movement and/or vibration from an accelerometer/gyroscope, damage and/or non-functionality of a component, and/or impact/contact through a tactile sensor. Such data may be used to determine whether the device has fallen, and/or whether the device is damaged. A lack of movement of the device after an apparent fall detected using one or more sensors or components may also indicate that the device is at rest in a new location, which may be hidden or obscured from the user. Additionally, an amount of time passed after the fall or when the device is in a new location and/or has new surrounding environmental data may be used to determine if the device has been misplaced or fallen from view.

Using such data, a new notification may be generated. The new notification may alert the user of the apparent fall, and may utilize sounds or displays to assist the user in finding the device. For example, a display screen or other visual output device may light up and maintain a high luminosity to assist in locating the device in a dark area. The notification may also include a sound notification, which may assist the user in finding the device, where the level and/or type of sound may be adjusted based on the detected ambient noise to maximize the chances that the user will hear the sound but possibly also not so loud that it startles the user or disturbs others. The notification or another notification may be sent to another device of the user to provide directions or location information of the device. Such a notification may be useful if the user is no longer in close proximity to the device (e.g., if the user did not hear or see the audio or visual notification and has left the location where the device is at), such that the user can then return the location indicated by the notification. The notification may also include other information determined using the motion data or detected location data, such as a direction the device fell and/or a distance the device fell. The notification may also alert the user of any potential or actual damage. In various embodiments, the notification may be transmitted to a server and/or another device, where the user may access the server/device to view the notification and find information on where the device may have fallen and been misplaced.

Thus, when a user places a device on a surface or otherwise releases control of the device, the device may detect motion data through one or more sensors and determine a related motion of the device relative to the surface or other object that the device has been placed on or against. The information of the motion may then be provided to the application or another application executing on the device for processing. Based on stored thresholds, conditions, and/or parameters required to be met for the motion, a notification, alert or other action/process may be determined. The device may utilize an output component of the device or associated with the device to output the notification. This allows a device to detect motions and/or movements that may pose a risk to the device Thus, a user may be informed of potential risk of impact damage to a computing device prior to the computing device suffering from the damage, which may reduce user costs and prevent damage and non-operation to computing devices.

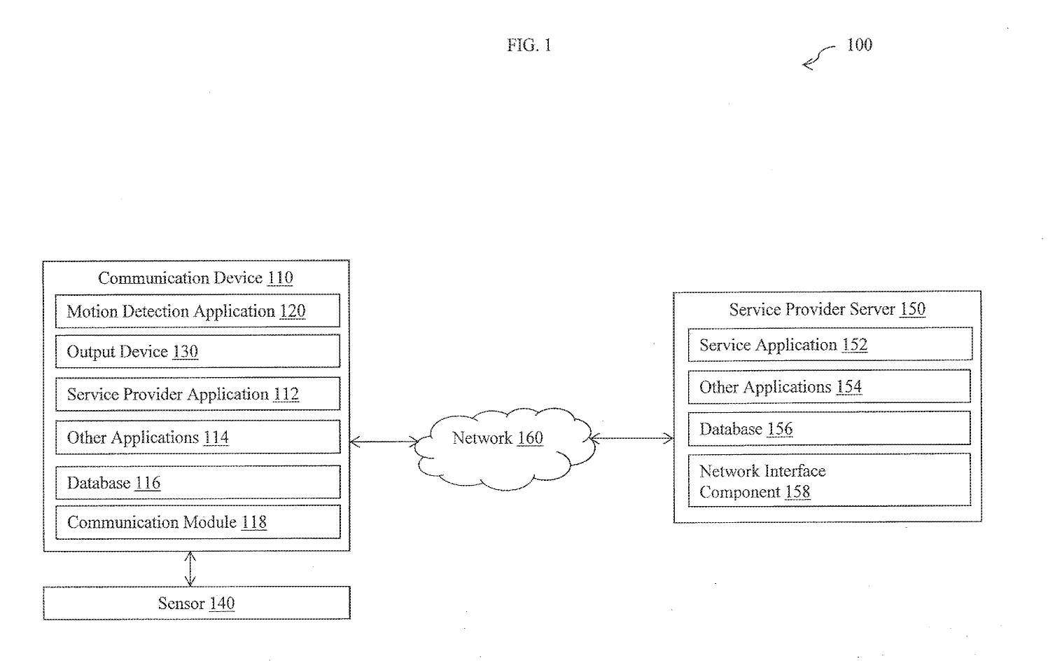

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a communication device 110, a sensor 140, and a service provider server 150 in communication over a network 160. The user (not shown) may utilize communication device 110 to utilize the various features available for communication device 110, which may include processes and/or applications executed by communication device 110. Communication device 110 may be placed one or against a surface or object, where communication device 110 is not in direct physical control by the user (e.g., is not in physical possession of the user). Communication device 110 may utilize sensor 140, which may be contained within or connected to communication device 110 to determine one or more motions of communication device 110 while outside of the control of the user. Based on the motions, communication device 110 may execute a process or action, which may include a notification output through communication device 110 or other output component/device. In certain embodiments, the action or process may also be processes by one or more features provided by service provider server 150.

Communication device 110 and service provider server 150 may each include one or more processors, memories, and other appropriate components for executing instructions such as program code and/or data stored on one or more computer readable mediums to implement the various applications, data, and steps described herein, as may sensor 140 where sensor 140 is a separate self-contained device connected with communication device 110. For example, such instructions may be stored in one or more computer readable media such as memories or data storage devices internal and/or external to various components of system 100, and/or accessible over network 160.

Communication device 110 may be implemented as a communication device that may utilize appropriate hardware and software configured for wired and/or wireless communication with sensor 140 and/or service provider server 150. For example, in one embodiment, communication device 110 may be implemented as a personal computer (PC), telephonic device, a smart phone, laptop/tablet computer, wristwatch with appropriate computer hardware resources, eyeglasses with appropriate computer hardware (e.g. GOOGLE GLASS®), other type of wearable computing device, and/or other types of computing devices capable of transmitting and/or receiving data. Communication device 110 may include or be associated with a sensor component or device, such as sensor 140, which may be physical contained, embedded, attached to, or included with communication device 110. In certain embodiments, sensor 140 may be external to communication device 110 and provide input data to communication device 110 (e.g., through a wired connection or wireless connection over short range wireless communications or a network), for example, a physically remote sensor from communication device 110 that is capable of capturing motion data of communication device 110 (e.g., a camera pointed at communication device 110, a vibrational sensor or tactile sensor placed on a surface with communication device 110, etc.). Although only one communication device is shown, a plurality of communication devices may function similarly.

Communication device 110 of FIG. 1 contains a motion detection application 120, an output device 130, a service provider application 112, other applications 114, a database 116, and a communication module 118. Motion detection application 120, output device 130, service provider application 112, and other applications 114 may correspond to executable processes, procedures, and/or applications with associated hardware. In other embodiments, communication device 110 may include additional or different modules having specialized hardware and/or software as required.

Motion detection application 120 may include one or more processes to utilize devices of communication device 110 to receive motion input data from sensor 140, process the data to determine a motion of communication device 110, and determine whether a notification is required to be output based on the motion. In this regard, motion detection application 120 may correspond to specialized hardware and/or software utilized by communication device 110 to first receive data from sensor 140 when communication device 110 is configured to receive motion data captured by sensor 140. Motion detection application 120 may process the motion data, in particular, the raw values indicative of a motion or movement of communication device 110, to determine a motion of communication device 110. The motion data received by sensor 140 may include detected values by sensor 140, such as a distance moved or traveled by communication device 110 in one or more directions. The directions may correspond to a one, two, or three-dimensional movements, such as a movement in an x, y, and/or z coordinate direction in spatial coordinates. The directions may also correspond to other motions and/or movements, including vibrational motions, spin, or other rotational movement by communication device 110. In further embodiments, the motion data may include values corresponding to one or more velocities of communication device 110 and/or acceleration(s) of communication device 110 over a period of time. Such types of data may be captured by gyroscope or accelerometer corresponding to sensor 140. Additional types of motion data may include data collected by a tactile or friction sensor corresponding to sensor 140, such as a friction force exerted on sensor 140. Sensor 140 may also correspond to a camera, where motion data may include one or more images or video that may be used to determine the aforementioned distance traveled,

Once the motion data is received from sensor 140 by motion detection application 120, motion detection application 120 may further determine an associated movement or motion of communication device 110 based on the motion data. The motion may correspond to a change in location (e.g., distance moved), a velocity, an acceleration, a vibrational frequency, a spin, and/or a force exerted on communication device 110. In order to provide determination of a motion of communication device 110, various features may be utilized with sensor 140, for example, utilizing the features and pressure detection processes associated with a gyroscope, accelerometer, friction sensor, camera, tactile sensor, radar type device, or other sensor that may be used to detection movement/motion of a device. Motion detection application 120 may process the raw motion data values in the motion data to determine the movement/motion of communication device 110. Motion detection application 120 may utilize multiple input data points to determine the movement/motion, for example, location, length, pattern, force, repeatability, etc.). Motion detection application 120 may further provide data for the motion to other applications for processing of the motion (e.g., service provider application 112) in the application, for example, to use one or more processes of such applications and/or execute one or more processes.

In response to determining the motion of communication device 110, motion detection application 120 may determine a notification or alert for output by an output component, such as output device 130. The notification may correspond to a communication that is output by output device 130. In order to determine whether a notification should be generated and/or output, and which notification to generate/output, motion detection application 120 may utilize the motion determined based on the motion data, and one or more conditions, parameters, or thresholds for generating/outputting the notification. In certain embodiments, no condition, parameter, or threshold may be required, or may be set to zero or any motion detection requirement. Thus, a notification may be generated and/or output in response to the detection of any motion data, or any specific motion data (e.g., any specific acceleration from resting or a velocity). The notification may also be generated and/or output in response to the motion meeting or exceeding a threshold, such as a minimum motion (e.g., distance moved, velocity, acceleration, etc.) that causes output of a notification. A condition or parameter may also be required to be met, for example, satisfying a particular motion (e.g., a rotational/vibrational motion), which may also be specific to device orientation. Thus, motion detection application 120 may allow for certain motions or movements up to a set maximum, depending on the state or status of communication device 110, prior to generation/output of a notification. Where multiple notifications for different and/or increasing motions are set, different conditions, parameters, or thresholds may be configured for each notification, which may include a base (including zero or any motion), and one or more further motion settings for each notification. The notification may include a basic notification, such as a display screen, sound, light display, etc. The notification may also be generated with specific data, including data entered by a user to be used in the notification and/or motion data related information of the motion that caused output of the notification. The notification may further include parameters for output, such as a time of output, length, brightness, repeatability, decibel level, etc., which can be based on environmental conditions detected, such as noise and/or brightness.

Once the notification is generated, output device 130 may be used to output the notification to a user associated with communication device 110. Output device 130 may correspond to one or more device components, systems, and/or devices, which may be integrated within communication device 110 as shown in system 100, or independent and connected to communication device 110 in other embodiments. In various embodiments, output device 130 may correspond to one or more hardware components configured to output and present data to a user, such as a notification generated and/or requested to be output by motion detection application 120. Output device 130 may include one or more audio and/or video outputs, which may include a speaker, a display screen or other video output device, one or more lights (e.g., LEDs or other light source), a haptic feedback unit or other type of audio and/or video output device. Output device 130 may also correspond to separate but connectable devices, including separate video display panels (e.g., computer monitors, televisions, etc.), headphone/headsets, connectable speakers, or other type of connectable output device. In various embodiments, output device 130 may further include an input component, for example, where output device 130 corresponds to an input/output (I/O) component that allows for input of device. In this regard, output device 130 may further include various types of input components, such as touch screen interfaces using resistive/capacitive touch inputs, microphones, keypads/keyboards, a computer mouse, a camera or other image/video capture device, etc. Such devices may also be internal or external to communication device 110. Output device 110 may receive the notification from motion detection application 120 and display the notification based on the output device type, the parameters for output, and the notification.

Once output device 130 has output the notification, motion detection application 120 may continue to detect motion data using sensor 140 and/or may detect a change in motion data based on data collected by sensor 140. In various embodiments, the change in previous motion data and/or new motion data may correspond to a change in previous velocity or acceleration and/or a further change in position. If motion detection application 120 determines that the change and/or new motion data no longer meets or exceeds the requirements (e.g., the parameter, threshold, or other condition) for output of the notification, motion detection application 120 may stop output of the notification and/or delete the notification. Such change or new motion data may indicate that the device is no longer in motion, for example, if sensor 140 stops detecting data indicating communication device 110 is in motion. In other embodiments, the change and/or new motion data may meet another parameter, threshold, or condition that is associated with ending one or more notifications, including the currently output notification, and may end output of the notification and/or delete the notification in response to satisfaction of the other requirements, such as securing the device, picking up the device by a user, etc.

Motion detection application 120 may also generate and/or output a notification in response to motion data or further collected data that indicates that the motion of communication device 110 has caused communication device 110 to move or fall, which may correspond to a threshold movement that is large enough to displace communication device 110 significantly where a user may be unable to locate communication device 110 and/or motion or data that indicates an impact with another surface. The notification may include information necessary to find communication device 110, including an audio output loud enough to locate communication device 110, a visual output visible in low light settings or with light visible in other particular settings (e.g., with high lumens for visibility even with many objects and/or high light in an environment), and/or a message that may be transmitted to another device. Motion detection application 120 may also utilize sensor 140 to determine the notification and the output for the notification, including the required audio, visual, and/or audiovisual content in the notification. For example, sensor 140 may be used to detect a movement and/or location of communication device 110, which may be used by motion detection application 120 to provide directions or other location data to location communication device 110. Sensor 140 may also detect ambient light and/or visibility, which may be used to determine whether a notification is necessary due to communication device 110 being displaced in a hidden or dark location and/or obscured. Communication device 110 may also generate the notification in response to an amount of time passing, for example, if sensor 140 has detected that communication device 110 is in a dark place for a substantial amount of time indicating that communication device 110 has fallen from view. Once the notification is determined, motion detection application 120 may output the notification using output device 130, and/or transmit to another device or server using communication module 118.

Service provider application 112 may correspond to one or more processes to execute software modules and associated components of communication device 110 to provide one or more features associated with service provider server 150. In this regard, service provider application 112 may correspond to specialized hardware and/or software utilized by communication device 110 to provide messaging applications, telephonic applications, social networking applications, fitness trackers and applications, media sharing or viewing applications, imaging application (e.g., a camera and associate application), microblogging applications, web browsing applications, and/or other types of applications. Service provider application 112 may be used to track motion data in certain embodiments, for example, when sensor 140 correspond to a separate but connected sensor, such as a fitness tracker, attachable mobile phone case, or other connected sensor including a physically attachable tactile or friction sensor to a body of communication device 110. In further embodiments, service provider application 112 may also be used to output a notification generated and/or requested to be output by motion detection application 120. Output of a notification by service provider application 112 may include output in another application or using another process and/or component/device connected with communication device 110. For example, the notification may be output in a media playback application, such as by pausing a song and outputting the notification through a speaker/headphones corresponding to output device 130. The output may also be displayed in another application and/or on another device. For example, service provider application 112 may utilize service provider server 150 to output the notification in an application or on another device that a user may be utilizing while sensor 140 detected motion of communication device 110. The user may be utilizing the other device while communication device 110 is out of the physical control of the user, and/or placed on a surface, where service provider server 150 may receive the notification and output the notification on the second device (e.g., through a notification in a home screen or window of an operating system, in a web browser, as a message in a messaging application, in a social networking application, etc.). The user may then see the notification on another device.

One or more of the aforementioned features and/or processes of motion detection application 120 may be included within service provider application 112 or vice versa, for example, to provide their respective features within one application and/or application interface.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 160, or other types of applications. Other applications 114 may also include email, texting, voice and IM applications that allow a user to send and receive emails, calls, texts, and other notifications through network 160. In various embodiments, other applications 114 may include financial applications, such as banking applications. Other applications 114 may also include other location detection applications, which may be used to determine a location for the user, such as a mapping, compass, and/or GPS application, which can include a specialized GPS receiver that obtains location information for communication device 110 and processes the location information to determine a location of communication device 110 and the user. Other applications may include transaction processing and/or merchant applications. Other applications 114 may include device interfaces and other display modules that may receive input from the user and/or output information to the user. For example, other applications 114 may contain software programs, executable by a processor, including a graphical user interface (GUI) configured to provide an interface to the user. Other applications 114 may therefore use devices of communication device 110, such as output device 110 capable of conveying information to users.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with service provider application 112 and/or other applications 114, identifiers associated with hardware of communication device 110, or other appropriate identifiers, such as identifiers used for payment/user/device authentication or identification, which may be communicated as identifying communication device 110 to service provider server 150. Database 116 may include motion detection information, such as threshold motion requirements or conditions, as well as data necessary to determine motions from motion data (e.g., process motion data values to determine one or more motions of communication device 110). Additionally, notifications set for particular motions and/or generated in response to motions may be stored to database 116.

Communication device 110 includes at least one communication module 118 adapted to communicate with sensor 140 and/or service provider server 150. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with nearby devices using short range communications, such as Bluetooth Low Energy, LTE Direct, WiFi, radio frequency, infrared, Bluetooth, and near field communications.

Sensor 140 may correspond to a hardware component of or associated with communication device 110 that may be motion sensitive, or otherwise capable of detecting motion, for example, a movement or motion of communication device 110 based on a force applied to communication device 110. Sensor 140 may be contained within communication device 110, such as an internal sensor of communication device 110, or may be embedded or contained within a body structure, hardware interface, attachable casing, or connectable device. In this regard, sensor 140 may correspond to a gyroscope, an accelerometer, a friction sensor, an ultrasonic radar system, an electromagnetic radar system, a camera, other type of tactile sensor, and/or another type of hardware device that may detect a presence and amount of movement or motion of communication device 110. Sensor 140 may also include or correspond to a pressure sensor to detect when communication device 110 is in possession of a user, such as a sensor in an attachable casing having embedded or surface mounted pressure sensitive devices, touch screen interface, and/or wraparound display screen, such as a display that may further include an output display component to display interfaces and associated data to a user (e.g., an electronic visual display utilized with operating systems and applications of communication device 110). Motion detection application 120 may collect or receive data resulting from a motion from sensor 140. Additionally, the motion data may correspond to a single input, such as a single movement or motion, or additional inputs, such as multiple motions. The motion data may include a time of input or length of input, as well as a number of inputs over a time period. Sensor 140 is shown separate from communication device 110 and connected to communication device 110, but may also be included with or internal to communication device 110. Although a single sensor is shown for sensor 140, multiple sensors internal and external to communication device 110 may function as described herein.

Service provider server 150 may be maintained, for example, by an online service provider, which may provide one or more services to users. In this regard, service provider server 150 includes one or more processing applications which may be configured to interact with communication device 110 and/or another device/server to facilitate output of notifications, as well as provide other services. In one example, service provider server 150 may be provided by PAYPAL®, Inc. of San Jose, Calif., USA. However, in other embodiments, service provider server 150 may be maintained by or include another type of service provider.

Service provider server 150 of FIG. 1 includes a service application 152, other applications 154, a database 156, and a network interface component 158. Service application 152 and other applications 154 may correspond to executable processes, procedures, and/or applications with associated hardware. In other embodiments, service provider server 150 may include additional or different modules having specialized hardware and/or software as required.

Service application 152 may correspond to one or more processes to execute software modules and associated specialized hardware of service provider server 150 to provide a service to the user associated with communication device 110, which may include a service used for output of a notification determined by communication device 110. In this regard, service application 152 may correspond to specialized hardware and/or software to provide one or more of a messaging, telephonic, social networking, fitness tracking, media sharing or viewing, microblogging, web browsing, and/or other types of service. Service application 152 may also receive a notification from communication device 110 for output in another application and/or through another device. Service application 152 may utilize a network connection with the device over network 160 to output the notification in an application of the other device. The user may be utilizing the other device while communication device 110 is out of the physical control of the user, and/or placed on a surface. Thus, service application 152 may receive the notification and transmit a communication including the notification to the other device. The other device may then display the notification using the notification data and any output parameters. The user may then see the notification on the other device based on the communication transmitted by service application 152.

In various embodiments, service provider server 150 includes other applications 154 as may be desired in particular embodiments to provide features to service provider server 150. For example, other applications 154 may include security applications for implementing server-side security features, programmatic client applications for interfacing with appropriate application programming interfaces (APIs) over network 160, or other types of applications. Other applications 154 may contain software programs, executable by a processor, including a graphical user interface (GUI), configured to provide an interface to the user when accessing service provider server 150, where the user or other users may interact with the GUI to more easily view and communicate information. In various embodiments, other applications 154 may include connection and/or communication applications, which may be utilized to communicate information to over network 160.

Additionally, service provider server 150 includes database 156. Account and/or user data may be stored in database 156, which may include user information, such as name, address, birthdate, payment instruments/funding sources, additional user financial information, user preferences, and/or other desired user data. Users may link to their respective data through an account, user, merchant, and/or device identifier. Thus, when an identifier is transmitted to service provider server 150, e.g., from communication device 110, user data may be found. Database 156 may also store received and/or communicated notifications.

In various embodiments, service provider server 150 includes at least one network interface component 158 adapted to communicate communication device 110 over network 160. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 160 may be implemented as a single network or a combination of multiple networks. For example, in various embodiments, network 160 may include the Internet or one or more intranets, landline networks, wireless networks, and/or other appropriate types of networks. Thus, network 160 may correspond to small scale communication networks, such as a private or local area network, or a larger scale network, such as a wide area network or the Internet, accessible by the various components of system 100.

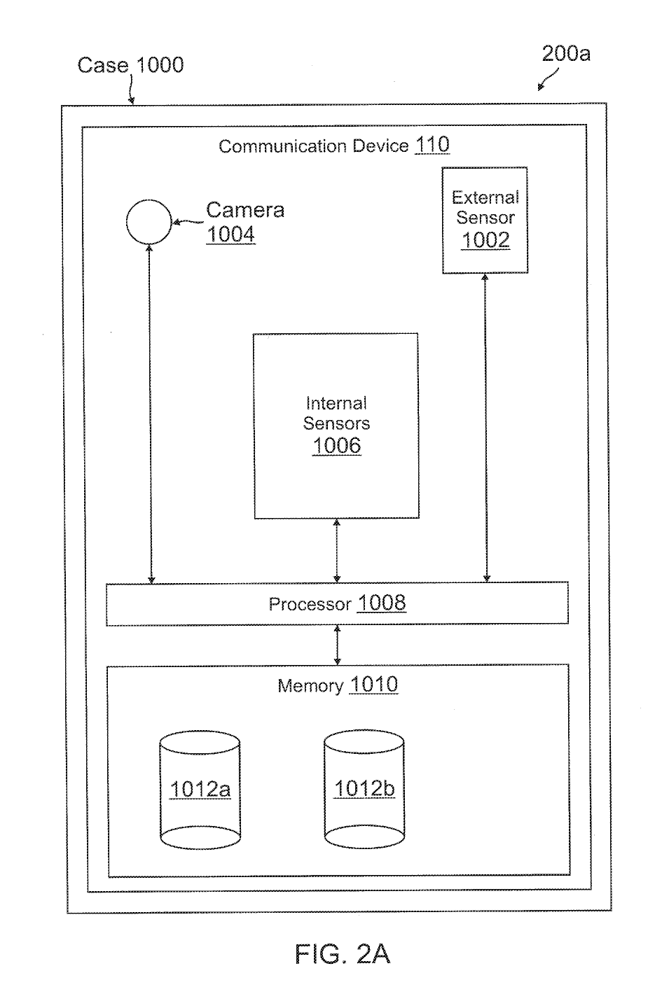

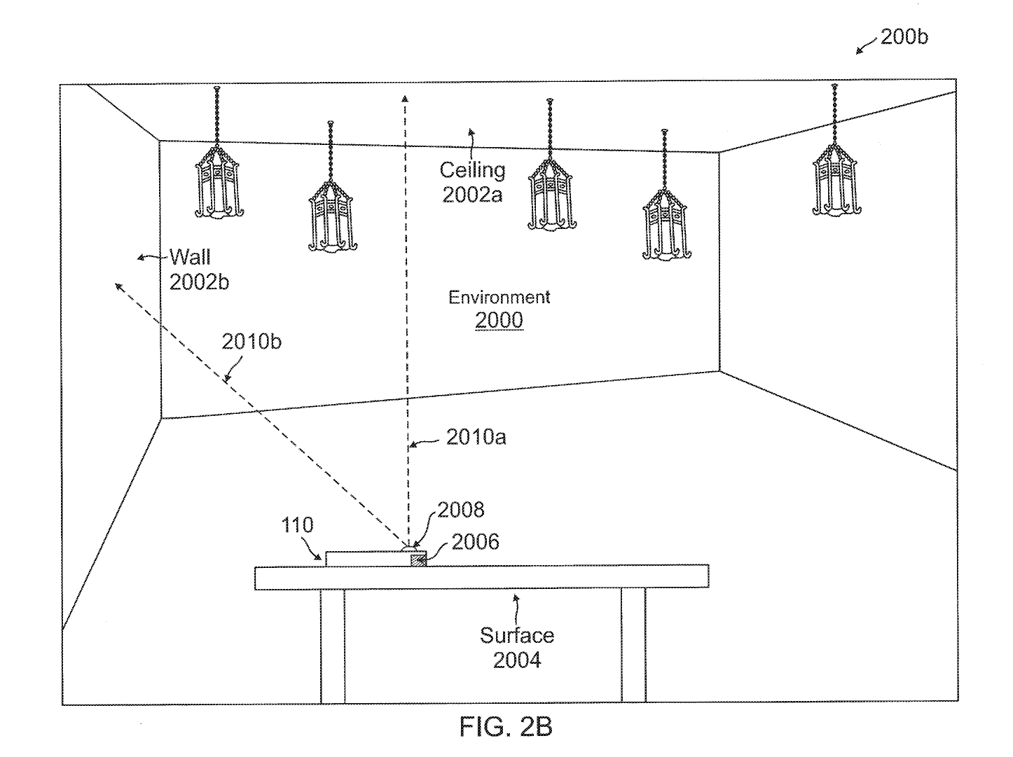

FIG. 2A is an exemplary device system for detecting movement or motion of the device system relative to a surface, according to an embodiment. Environment 200a includes a communication device 110 corresponding generally to the described features, processes, and components of communication device 110 in system 100 of FIG. 1.

In this regard, communication device 100 is physically connected to a case 1000, which may include an external sensor 1002 embedded within case 1000, physically connected to case 1000, or associated with case 1000. In other embodiments, external sensor 1002 may instead be connected to communication device 110 either directly (e.g., physically) to a body or external shell of communication device 110, or remotely, and communication device 110 may not include case 1000. External sensor 1002 may be utilized to detect motion data of communication device 110, for example, relative to a surface associated with communication device 110. Communication device 110 may further include camera 1004 and internal sensors 1006 that may further be used to detect motion data of communication device 110. External sensor 1002 and/or internal sensors 1006 may include one or more of a gyroscope, an accelerometer, a friction sensor, a ultrasonic radar system, and/or an electromagnetic radar system.

Utilizing external sensor 1002, camera 1004, and/or internal sensors 1006, motion data may be transmitted to processor 1008, which may be processed using data stored to memory 1010. For example, memory 1010 may include a database 1012a containing instructions for triggering movement or motion events that cause execution of a process or action, such as generation and/or output of a notification or alert. Database 1012b may include instructions for processes or actions to execute in response to the triggering events in database 1012a. Thus, processor 1008 may utilize databases 1012a and 1012b in memory 1010 to determine whether a motion determined from motion data may cause generation and/or output of data from memory 1010. Thus, in one exemplary embodiment, processor 1008 may receive motion data from one or more of external sensor 1002, camera 1004, and/or internal sensors 1006 when communication device 110 is in motion or has been moved, such as a change in location or distance moved, velocity, acceleration, or other motion data in one or more directions in three-dimensional space. The motion data may further include image/video data, friction data, or other data that may be used to determine whether communication device 110 is in motion by processor 1008. Once the motion is determined, processor 1008 may access database 1012a in memory 1010, and determine whether a satisfying condition, parameter, and/or threshold has been met for generation and/or output of a notification. If so, database 1012b may be utilized to determine and output of the notification by processor 1008, which may then utilize an output component to output the notification.

FIG. 2B is an exemplary environment including a mobile device in physical contact with a first surface and nearby a second surface, which may be used to determine a movement or motion of the device relative to the first surface and/or second surface, according to an embodiment. Environment 200b includes a communication device 110 corresponding generally to the described features, processes, and components of communication device 110 in system 100 of FIG. 1. In this regard, a user utilizing communication device 110 may place communication device 110 in a location or an environment where the user does not have physical control, and therefore communication device 110 is at risk of slipping and falling from a surface or object and receiving impact damage. Thus, communication device 110 may execute one or more of the processes of motion detection application 120 in system 100 to determine any motion or movement of communication device 110.

Communication device 110 is shown as placed in an environment 200, where communication device 110 is not in physical possession of a user and/or attached to a user/object so that communication device 110 is secured. In this regard, communication device 110 may be at a greater risk of falling and/or receiving impact damage in response to a movement or motion of communication device 110. Environment 2000 is shown with a ceiling 2002a, a wall 2002b, a surface 2004, and communication device 110 placed on surface 2004 so that communication device 110 is in contact with surface 2004. Surface 2004 may correspond to a surface of a piece of furniture or other object, such as a table or desk, but may also correspond to other types of objects that a user may place an object on, including car interior objects, workout machines, or other objects having a surface that may allow for a user to place communication device 110 on and allow communication device 110 to rest in a place. Communication device 110 is shown having a sensor 2006 and a camera 2008, which may be used to determine any movement or motion of communication device 110 relative to surface 2004.

While communication device 110 is resting on surface 2004, communication device 110 may begin to move, for example, if surface 2004 is not flat and/or if a force is exerted on communication device 110 (e.g., gravity, shaking, wind, etc.). Additionally, communication device 110 may also exert a force, for example, with a haptic feedback component and a vibrational alert (e.g., for incoming calls/messages). The force exerted on communication device 110 may cause communication device 110 to begin moving, and may be displaced in one or more directions, as well as receive acceleration in one or more directions to a velocity. Such movement and/or forces may be detected by sensor 2006, which may correspond to a gyroscope, accelerometer, and/or friction sensor that may detect outside forces exerted on communication device 110. Utilizing such data, communication device 110 may determine a motion of communication device 110, and may generate and/or output a notification based on the motion, as discussed herein. Thus, a user may be notified of the motion of communication device 110 prior to communication device falling from surface 2004 or otherwise risking impact damage based on continuous or additional movement/motion.

Communication device 110 may also utilize camera 2008 to determine a motion of communication device 110. For example, camera 2008 may be used to capture video and/or image data of ceiling 2002a and/or wall 2002b. A distance 2010a and/or a distance 2010b may be determined using the video/image data captured by camera 2008. When communication device 110 begins moving, or after another period of time, distances 2010a and 2010b may be recalculated and a distance moved, velocity, and/or acceleration may be determined (which may require additional information, such as time between capture of image/video data, etc.). Communication device 110 may utilize the image data to determine that communication device 110 has been moved or is in motion, and may then generate and/or output a notification as discussed herein. Thus, a camera included with or connected to communication device 110 may also be utilized to notify a user of past and/or present movement/motion of communication device 110 prior to communication device 110 receiving impact damage from the continuous or additional movement/motion. In further embodiments, camera 2008 may be remote from communication device 110 and capture image/video of communication device 110 over time to measure distance moved, velocity, and/or acceleration as discussed herein.

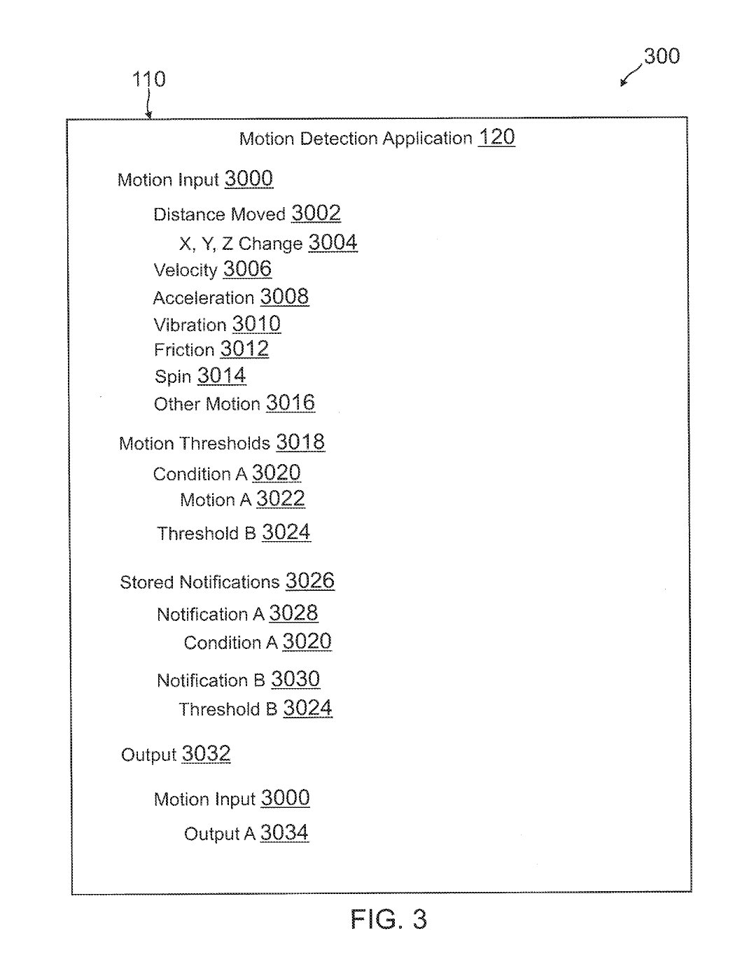

FIG. 3 is an exemplary system environment showing a communication device of a user receiving data for a movement or motion of the device and determining whether to output a notification to a user of the movement or motion, according to an embodiment. FIG. 3 includes communication device 110 discussed in reference to system 100 of FIG. 1.

Communication device 110 executes motion detection application 120 corresponding generally to the specialized hardware and/or software modules and processes described in reference to FIG. 1. In this regard, motion detection application 120 includes motion input data detected by one or more sensors, and additional stored data that causes output of notifications when communication device 110 has been moved or is in motion. For example, motion input 3000 may include one or more values to determine whether communication device 110 has been moved, is in motion, and the amount, degree, or other quantitative measure of that motion. Motion input 3000 includes distance moved 3002, such as a change in location, which may be measured in an x, y, z change 3004 (e.g., a change is spatial coordinates and/or values in a spatial measurement system). Motion input may also include one or more of velocity 3006 (e.g., feet(f)/second(s), meters(m)/s, or some other measure per a time value), acceleration 3008 (e.g., f/s² or some other measure per time value squared), vibration 3010 (which may be measured in back and forth movement, such as a vibrational frequency, repeated motions per a time value, etc.), friction 3012 (which may be measured as a force value utilizing a co-efficient of friction for a surface or other matter), spin (e.g., rotations or other movement about an axis per some time value), and/or some other motion 3016.

Motion threshold 3018 may be used to determine whether motion input 300 meets or exceeds a threshold or condition that required motion detection application 120 to output a notification in response to the motion in motion input 3000. For example, motion thresholds 3018 may include a condition A 3020 that is required to be met, such as a motion A 3022, prior to generation and/or output of a notification using motion detection application 120. Motion thresholds 3018 may include multiple thresholds or conditions, including threshold B 3024. Motion thresholds 3018 may be stored and held in a memory with stored notifications 3026, which may be used to generate and/or output one or more notifications in response to motion input 3000 meeting, exceeding, or otherwise satisfying one or more criteria in motion thresholds 3018.

Stored notifications 3026 may therefore include a notification A 3028 and a notification B 3030, which may be output based on motion thresholds 3018. In this regard, notification A 3028 may be associated with condition A 3020 while notification B 3030 may be associated with threshold B 3024. Thus, when condition A 3020 is met, notification A 3028 may be output, whereas when threshold B 3024 is met or exceeded, notification B 3030 may be output. Using motion input 3000 with motion thresholds 3018 and stored notifications 3026, output 3032 may be determined. For example, motion input 3000 may satisfy one or more of motion thresholds 3018 that cause output of stored notifications 3026 and may be used to generate output A 3034. After generation of output A 3034, motion detection application 120 may utilize an output component or device of communication device 110 to communicate output A 3034 to one or more users.

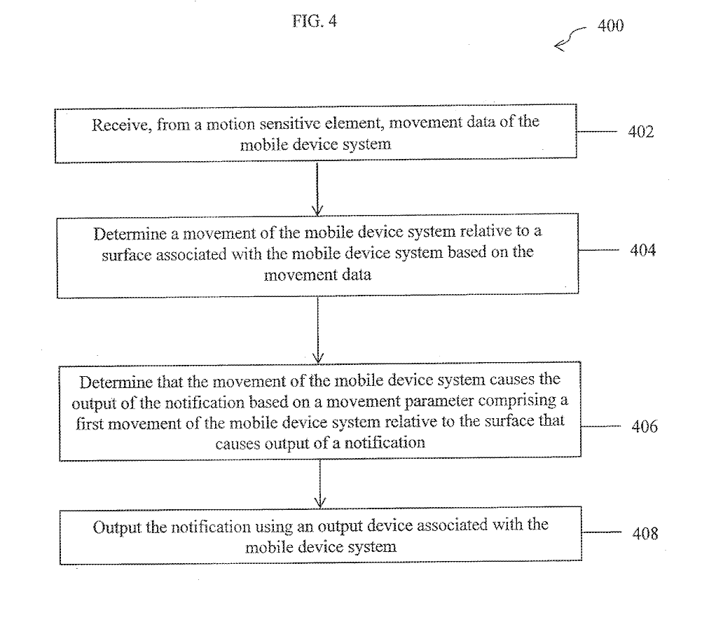

FIG. 4 is a flowchart of an exemplary process used by sensor elements to detect object movement relative to a surface, according to an embodiment. Note that one or more steps, processes, and methods described herein may be omitted, performed in a different sequence, or combined as desired or appropriate in flowchart 400 of FIG. 4.

At step 402 of flowchart 400, there is received, from a motion sensitive element, movement data of the mobile device system. The motion sensitive element may comprise one of a gyroscope, an accelerometer, a friction sensor, an ultrasonic radar system, an electromagnetic radar system, or a camera. The movement data may comprises one of a directional velocity of the mobile device system detected by the motion sensitive element, a friction force exerted on the motion sensitive element, an acceleration speed of the mobile device system detected by the motion sensitive element, or a vibration of the mobile device system detected by the motion sensitive element. In this regard, movement or motion data may measure a change in position or location of the mobile device system in one or more directions in three-dimensional space, which may be measured over time or by distance. Moreover, the movement or motion data may comprise multiple sensor inputs.

A movement of the mobile device system relative to a surface associated with the mobile device system is determined based on the movement data, at step 404 of flowchart 400. The movement of the mobile device system may be entered to a structural component of the mobile device system, wherein the structural component comprises one of an attachable sensor for the mobile device system, an exterior body of the mobile device system, a touch screen of the mobile device system, or an attachable casing for the mobile device system. The surface may comprise a furniture surface physically connected to the mobile device system, wherein the motion sensitive element is in physical contact with the surface to detect the movement data. In other embodiments, the surface may comprise an environment surface in an environment containing the mobile device system, wherein the environment surface is not physically connected to the mobile device system, and wherein the motion sensitive element comprises a camera that detects the movement data. Where the movement or motion data comprises multiple sensor inputs, there may be more than one surface, where a first surface may be physically connected to the device/system and a second surface is not connected.

At step 406 of flowchart 400, it is determined that the movement of the mobile device system causes the output of the notification based on a movement parameter comprising a first movement of the mobile device system relative to the surface that causes output of a notification. The first movement for the movement parameter may comprise one of a threshold directional velocity of the mobile device system, a threshold friction force exerted on the motion sensitive element of the mobile device system, a threshold acceleration speed of the mobile device system in a direction, or a threshold vibrational oscillation of the mobile device system. In various embodiments, the parameter may comprise a condition for notifying the user, such as an indication that the movement of the device causes the device to separate from the contact with the surface. An orientation of the device may also be used to determine or adjust the parameter or threshold for generation and/or output of the notification.

At step 408 of flowchart 400, the notification is output using an output device associated with the mobile device system. The notification may comprise one of a visual alert, an audio alert, or an audiovisual alert, and wherein the output device comprises one of a speaker, a microphone, headphones, or a display interface. In various embodiments, a request to establish the movement parameter may be received and input data comprising the first movement of the mobile device and the notification for output in response to detecting the first movement may be entered to/received by the mobile device system. The first movement and the notification may then be stored as the movement parameter. The input data for the first movement may comprise a threshold movement of the mobile device system. Thus, determining the movement causes the output may comprise determining that the movement of the mobile device system meets or exceeds the threshold movement. Additionally, it may be determined that there is a change in location of the mobile device system, such as a user picking up the mobile device system and traveling with the mobile device system. If the change meets a condition for stability, such as being secured or held by the user, output of the notification may be disabled. In one embodiment, if the user associated with the device is detected as being away (e.g., outside a distance the user may pick up the device, such as two feet) such that it is more likely a different user has picked up the device, the notifications may continue. Such a detection may be through a different wearable or mobile device on or with the user, which may be configured to determine a location of the user or the distance between the user and the device. For example, received signal strength indication (RSSI) and/or signal triangulation may be used to estimate and/or determine locations of devices relative to each other and distances between devices. This provides an additional benefit of possible theft detection and prevention of the device.

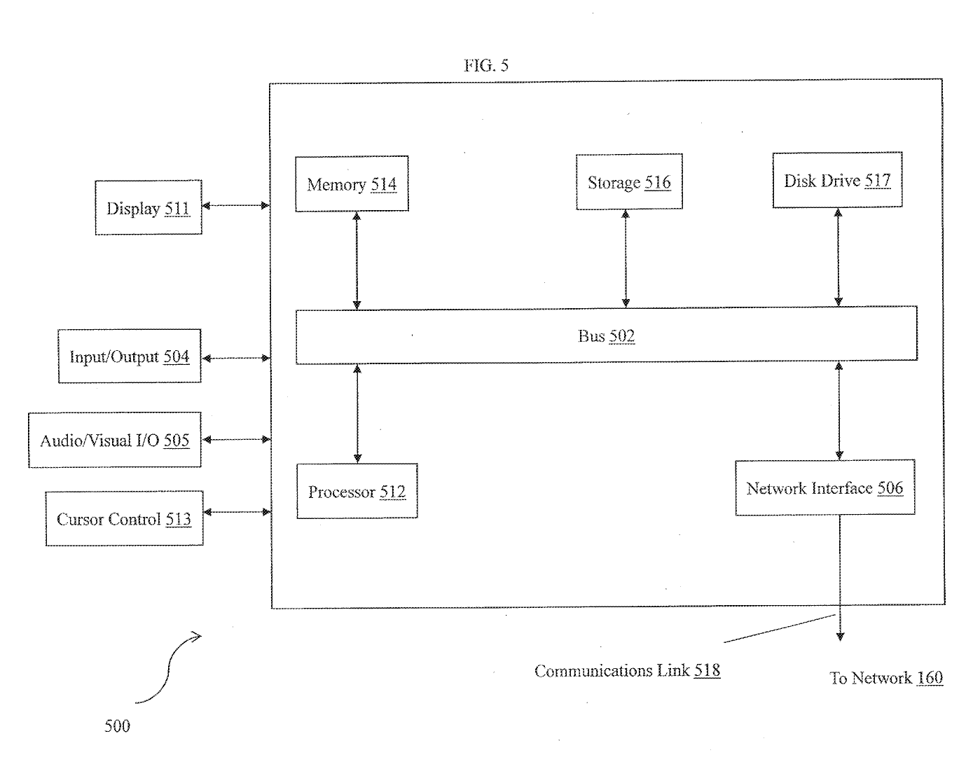

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 160. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A mobile device system comprising:
a motion sensitive element that detects a movement of the mobile device system relative to a surface associated with the mobile device system;
a non-transitory memory storing a movement parameter of the mobile device system, wherein the movement parameter comprises a first movement of the mobile device system relative to the surface associated with output of a first notification; and
one or more hardware processors configured to execute instructions to cause the mobile device system to perform operations comprising:
receiving, from the motion sensitive element, movement data of the mobile device system;
determining the movement of the mobile device system relative to the surface based on the movement data;
determining, from the non-transitory memory, that the movement of the mobile device system is associated with the output of the first notification based on the movement parameter; and
outputting the first notification using an output device associated with a user of the mobile device system.

2. The mobile device system of claim 1, wherein the motion sensitive element comprises one of a gyroscope, an accelerometer, a friction sensor, a ultrasonic radar system, an electromagnetic radar system, or a camera.

3. The mobile device system of claim 1, wherein the movement data comprises one of a directional velocity of the mobile device system detected by the motion sensitive element, a friction force exerted on the motion sensitive element, an acceleration speed of the mobile device system detected by the motion sensitive element, or a vibration of the mobile device system detected by the motion sensitive element.

4. The mobile device system of claim 1, wherein the first movement for the movement parameter comprises one of a threshold directional velocity of the mobile device system, a threshold friction force exerted on the motion sensitive element of the mobile device system, a threshold acceleration speed of the mobile device system in a direction, or a threshold vibrational oscillation of the mobile device system.

5. The mobile device system of claim 1, wherein the operations further comprise:
receiving a request to establish the movement parameter;
receiving input data comprising the first movement of the mobile device and the first notification for output in response to detecting the first movement; and
storing the first movement and the first notification as the movement parameter.

6. The mobile device system of claim 5, wherein the input data for the first movement comprises a threshold movement of the mobile device system, and wherein the determining that the movement causes the output comprises:
determining that the movement of the mobile device system meets or exceeds the threshold movement.

7. The mobile device system of claim 1, wherein the movement of the mobile device system is entered to a structural component of the mobile device system, and wherein the structural component comprises one of an attachable sensor for the mobile device system, an exterior body of the mobile device system, a touch screen of the mobile device system, or an attachable casing for the mobile device system.

8. The mobile device system of claim 1, wherein the first notification comprises one of a visual alert, an audio alert, or an audiovisual alert, and wherein the output device comprises one of a speaker, a microphone, headphones, or a display interface.

9. The mobile device system of claim 1, wherein the surface comprises a furniture surface physically connected to the mobile device system, and wherein the motion sensitive element is in physical contact with the surface to detect the movement data.

10. The mobile device system of claim 1, wherein the surface comprises an environment surface in an environment containing the mobile device system, wherein the environment surface is not physically connected to the mobile device system, and wherein the motion sensitive element comprises a camera that detects the movement data.

11. The mobile device system of claim 1, wherein the operations further comprise:
detecting environmental data around the mobile device system; and
determining a second notification based at least on the environmental data, wherein the second notification alerts the user of the environmental data.

12. The mobile device system of claim 11, wherein the environmental data comprises at least one of a noise level or a brightness level, and wherein the determining the second notification based at least on the environmental data comprises:
determining that the mobile device system has been moved from the surface based on the motion data and the environment data; and
generating the second notification in response to the mobile device system being moved from the surface.

13. A method comprising:
receiving, from a first motion sensor of a device, first motion data of the device;
determining a motion of the device relative to a first surface associated with the device using the first motion data;
determining whether the motion at least meets a motion threshold for alerting a user associated with the device; and
in response to determining that the motion at least meets the motion threshold, causing output of a notification of the motion through an output of the device or of another device associated a user of the device.

14. The method of claim 13, further comprising:
receiving, from a second motion sensor of the device, second motion data of the device,
wherein the motion of the device is further determined relative to a second surface associated with the device using the second motion data.

15. The method of claim 14, wherein the first surface is in physical contact with the device, and wherein the second surface is not in physical contact with the device.

16. The method of claim 14, wherein the first motion sensor comprises one of a tactile sensor or a friction sensor, and wherein the second motion sensor comprises a camera.

17. The method of claim 13, further comprising:
determining a change in location of the device;
determining that the change in location of the device satisfies a condition for stability of the device with the surface; and
disabling output of the notification based on the motion threshold.

18. The method of claim 13, further comprising:
determining that the mobile device system is in one of a horizontal orientation or a vertical orientation; and
adjusting the motion threshold based on the one of the horizontal orientation or the vertical orientation.

19. A non-transitory machine-readable medium having stored thereon machine-readable instructions executable to cause a machine to perform operations comprising:
determining, using an input device associated with a mobile device, a movement of the device in relation with a surface in contact with the device;
determining that the movement of the mobile device satisfies a condition for notifying a user associated with the device of the movement;
generating a first notification of the movement for the user; and
outputting the first notification using an output device associated with the user of the mobile device.

20. The non-transitory machine-readable medium of claim 19, wherein the condition for notifying the user comprises an indication that the movement of the device causes the device to separate from the contact with the surface, and wherein the operations further comprise:
determining that an amount of time has passed since the movement of the device has caused the device to separate from the contact with the surface;
determining an ambient light level surrounding the device; and
outputting a second notification associated with the amount of time and the ambient light level, wherein the second notification alerts the user of the location of the device.
